(19) United States
(12) Patent Application Publication
(10) Pub. No.: US 2015/0356876 A1
(43) Pub. Date: Dec. 10, 2015

(54) EMOTION REGULATION SYSTEM AND REGULATION METHOD THEREOF

(71) Applicant: National Cheng Kung University, Tainan City (TW)

(72) Inventors: Jeen-Shing WANG, Tainan City (TW); Ching-Ming LU, Tainan City (TW); Yu-Liang HSU, Kaohsiung City (TW); Wei-Chun CHIANG, Kaohsiung City (TW)

(21) Appl. No.: 14/730,820

(22) Filed: Jun. 4, 2015

(30) Foreign Application Priority Data
Jun. 4, 2014 (TW) 103119347

(51) Int. Cl. G09B 5/04

(52) U.S. Cl. CPC G09B 5/04

(57) ABSTRACT

An emotion regulation system and a regulation method thereof are disclosed. A physiological emotion processing device of the emotion regulation system comprises an emotion feature processing unit and a physiological emotion analyzing unit. The emotion feature processing unit outputs a physiological feature signal according to a physiological signal generated by a user listening to a first music signal. The physiological emotion analyzing unit analyzes the user's physiological emotion according to the physiological feature signal and generates a physiological emotion state signal. A music feature processing unit of a musical emotion processing device obtains corresponding music feature signals from music signals. A music emotion analyzing processing unit analyzes the music feature signals to obtain musical emotions of the music signals and outputs a corresponding second music signal to the user according to the physiological emotion state signal and a target emotion.

### CROSS REFERENCE TO RELATED APPLICATIONS

This Non-provisional application claims priority under 35 U.S.C. §119(a) on Patent Application No(s). 103119347 filed in Taiwan, Republic of China on Jun. 4, 2014, the entire contents of which are hereby incorporated by reference.

### BACKGROUND OF THE INVENTION

1. Field of Invention

This invention relates to an emotion regulation system and a regulation method thereof and, in particular, to an emotion regulation system and a regulation method thereof which can regulate the human physiological emotion to a predetermined emotion by music.

2. Related Art

In this busy modern society, heavy working pressure and living burden pose a grave threat to the human physiological and psychological health. When humans stay under a high-intensity pressure for a long period of time, humans will easily encounter sleep disorder (such as insomnia), emotional disturbance (e.g. anxiety, melancholy, nervousness) or even cardiovascular diseases. Therefore, it appears really important to timely examine the own physiological and emotional state and seek a regulation method suitable for the own physiological and emotional state so as to enhance the life quality and avoid the diseases caused by the overmuch pressure.

Since music has no borders between countries and is always the best choice for reducing pressure and enhancing relaxation in body and mind. Therefore, it is an important subject how to use proper music to regulate the human physiological emotion to the predetermined emotion, for example, from the sad emotional state to the happy emotional state or from the excited emotional state to a peaceful emotional state.

### SUMMARY OF THE INVENTION

In view of the above subject, an objective of this invention is to provide an emotion regulation system and a regulation method thereof whereby the user's physiological emotion can be gradually regulated to a predetermined target emotion so as to enhance the human physiological and psychological health.

To achieve the above objective, an emotion regulation system regulating according to this invention can regulate a physiological emotion of a user to a target emotion and comprises a physiological emotion processing device and a musical emotion processing device. The physiological emotion processing device comprises an emotion feature processing unit and a physiological emotion analyzing unit. The emotion feature processing unit outputs a physiological feature signal according to a physiological signal generated by the user listening to a first music signal, and the physiological emotion analyzing unit analyzes the user's physiological emotion according to the physiological feature signal and generates a physiological emotion state signal. The musical emotion processing device is electrically connected with the physiological emotion processing device and comprises a music feature processing unit and a music emotion analyzing processing unit. The music feature processing unit obtains a plurality of corresponding music feature signals from a plurality of music signals, and the music emotion analyzing processing unit analyzes the music feature signals to obtain musical emotions of the music signals and outputs a corresponding second music signal to the user according to the physiological emotion state signal and the target emotion.

To achieve the above objective, an emotion state regulation method of this invention is applied with an emotion regulation system and can regulate a physiological emotion of a user to a target emotion. The emotion regulation system comprises a physiological emotion processing device and a musical emotion processing device, the physiological emotion processing device comprises an emotion feature processing unit and a physiological emotion analyzing unit and the musical emotion processing device comprises a music feature processing unit and a music emotion analyzing processing unit. The regulation method comprising steps of: obtaining a plurality of corresponding music feature signals from a plurality of music signals by the music feature processing unit through a music feature accessor method; analyzing the music feature signals to obtain musical emotions of the music signals by the music emotion analyzing processing unit; selecting a first music signal the same as the target emotion from the musical emotions of the music signals and outputting the first music signal; sensing a physiological signal generated by the user listening to the music signal and outputting a physiological feature signal by the emotion feature processing unit according to the physiological signal; analyzing the user's physiological emotion by the physiological emotion analyzing unit according to the physiological feature signal to generate a physiological emotion state signal; comparing the physiological emotion state signal with a target emotion signal of the target emotion by the music emotion analyzing processing unit; and selecting a second music signal the same as the target emotion from the musical emotions of the music signals and outputting the second music signal, when the physiological emotion state signal and the target emotion signal don't conform to each other.

As mentioned above, in the emotion regulation system and the regulation method thereof according to this invention, the emotion feature processing unit of the physiological emotion processing device can output the physiological feature signal according to the physiological signal generated by the user listening to the first music signal, and the physiological emotion analyzing unit analyzes the user's physiological emotion according to the physiological feature signal and generates the physiological emotion state signal. Moreover, the music feature processing unit of the musical emotion processing device can obtain a plurality corresponding music feature signals from a plurality of music signals, and the music emotion analyzing processing unit analyzes the music feature signals to obtain the musical emotions of the music signals and outputs the corresponding second music signal to the user according to the physiological emotion state signal and the target emotion. Thereby, the emotion regulation system and the regulation method of this invention can gradually regulate the user's physiological emotion to the predetermined target emotion, so as to enhance the human physiological and psychological health.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a two-dimensional emotion plane about the physiological emotion and the musical emotion;

FIG. 1B is a function block diagram of an emotion regulation system of an embodiment of the invention;

FIG. 1C is another function block diagram of an emotion regulation system of an embodiment of the invention;

FIG. 2A is a schematic diagram of the brightness feature;

FIG. 2B is a schematic diagram of the spectral roll-off feature;

FIG. 2C is a schematic diagram of the spectrum analysis of the music signal;

FIG. 2D is a schematic diagram of the chromagram of the music signal;

FIG. 2E is a schematic diagram of the features of the music signal;

FIG. 2F is a schematic diagram of another tempo features;

FIG. 2G is a schematic diagram of the envelope of the music signal;

FIG. 3 is a function block diagram of an emotion regulation system of another embodiment of the invention; and

FIG. 4 is a schematic flowchart of an emotion state regulation method of an embodiment of the invention.

### DETAILED DESCRIPTION OF THE INVENTION

The present invention will be apparent from the following detailed description, which proceeds with reference to the accompanying drawings, wherein the same references relate to the same elements.

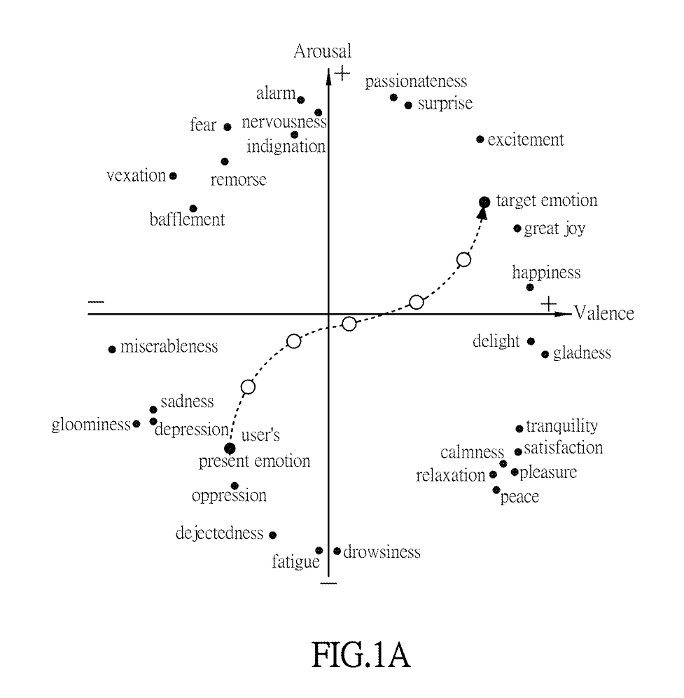

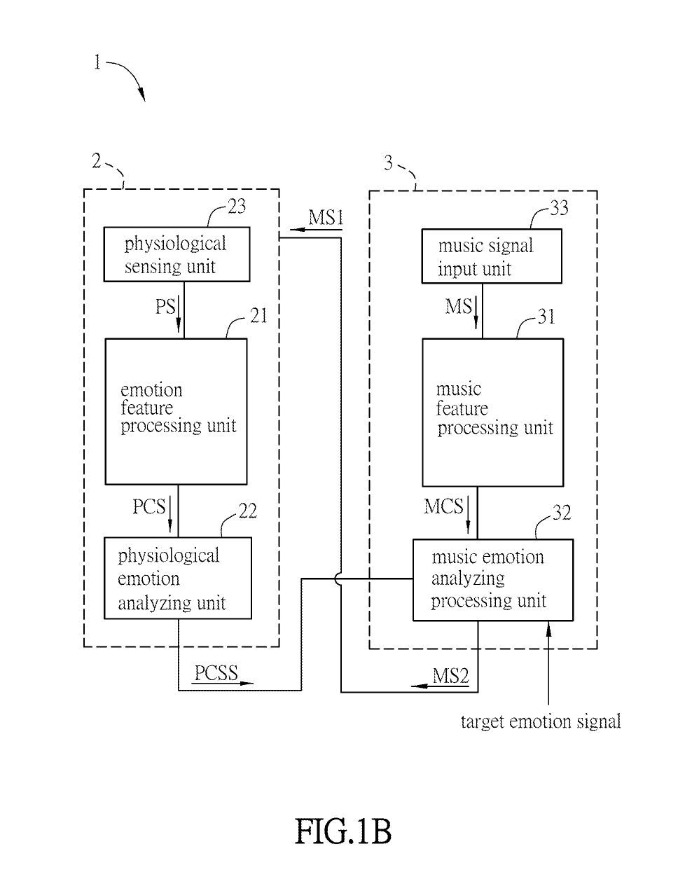

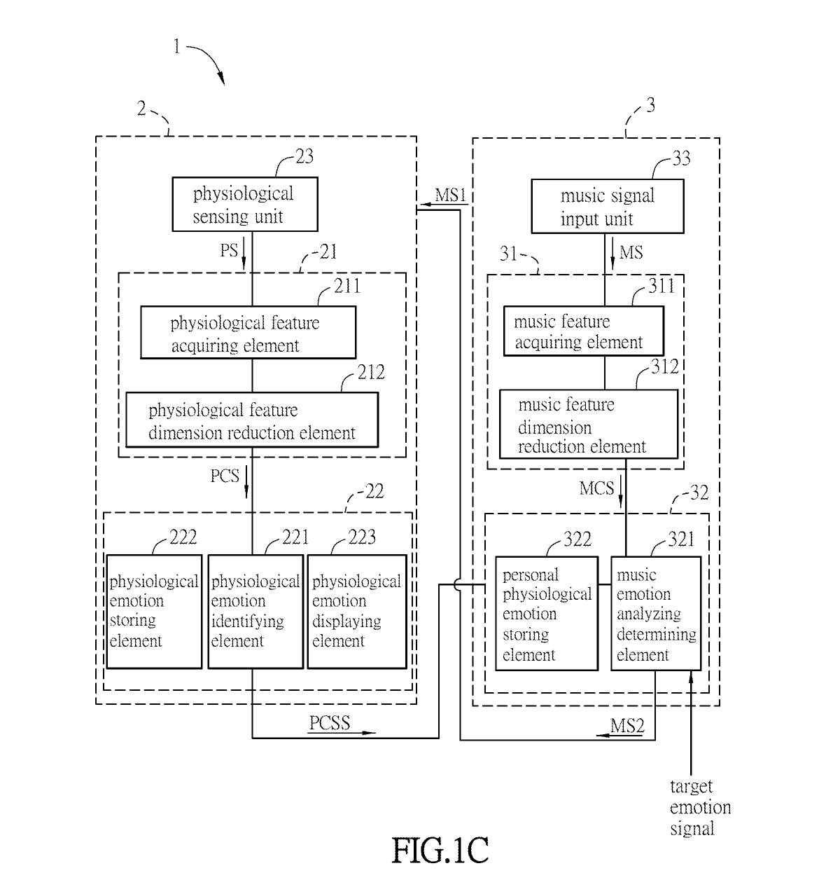

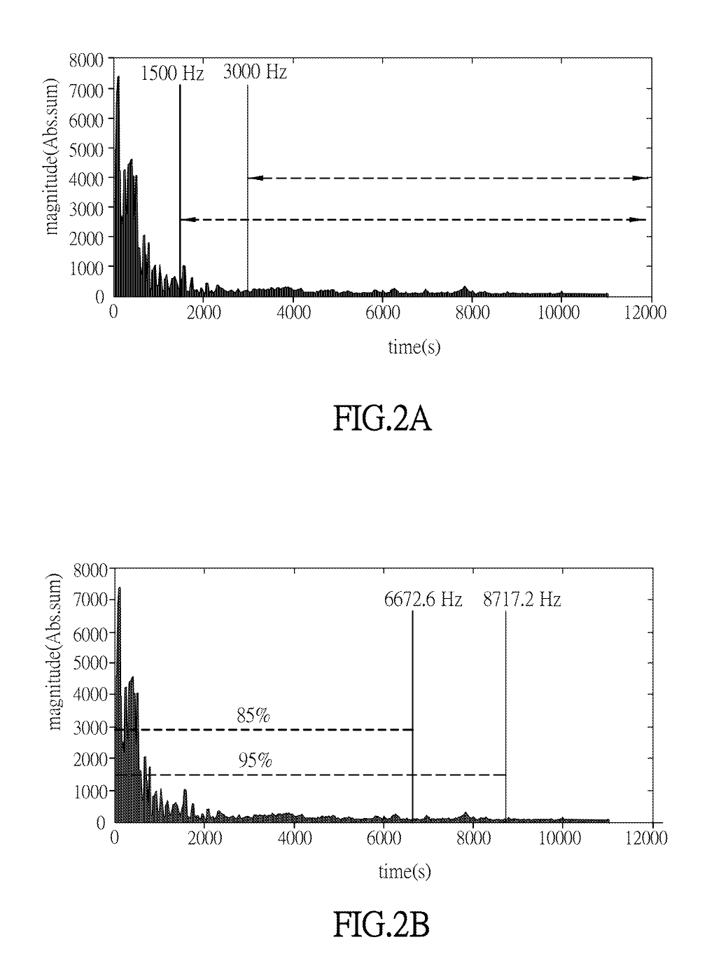

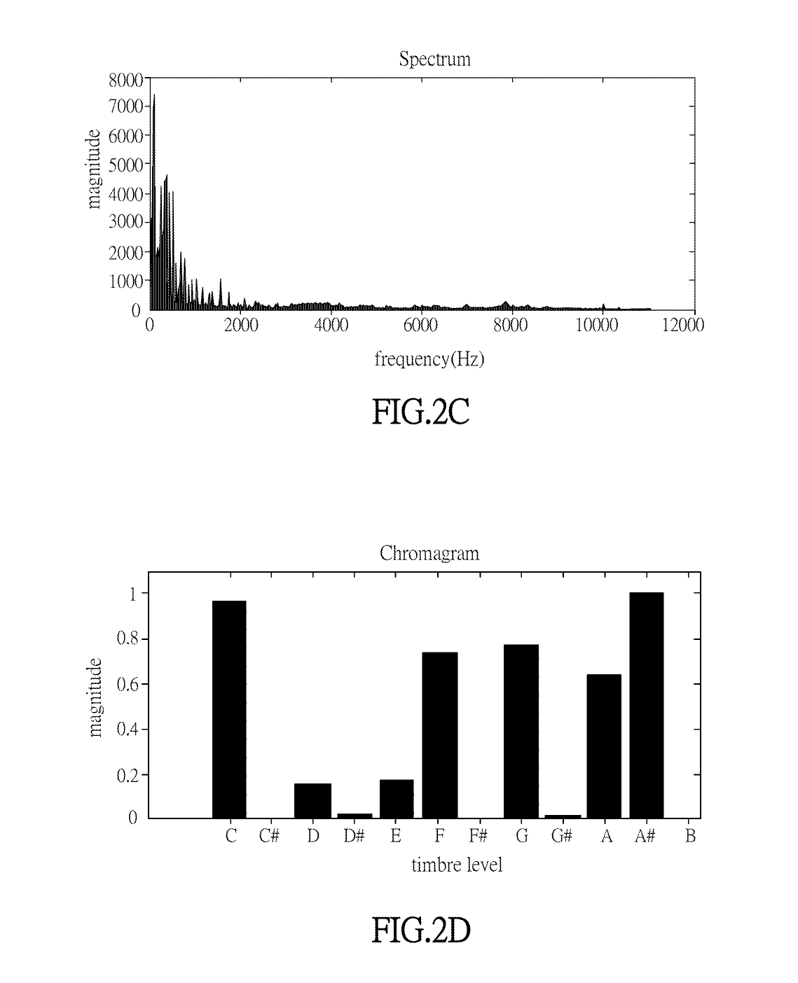

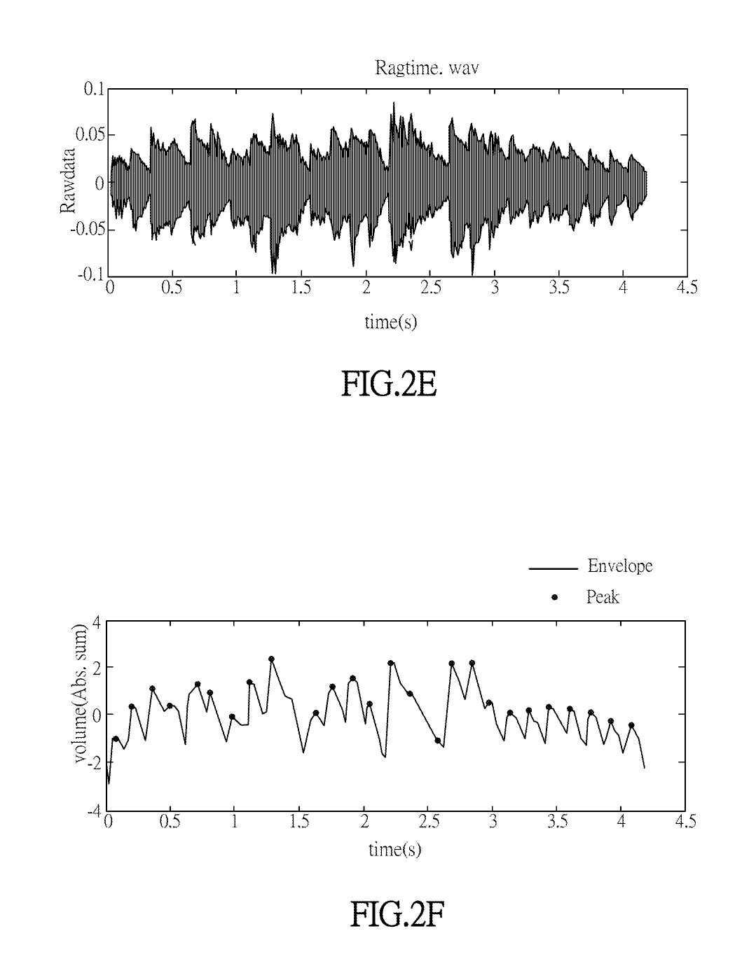

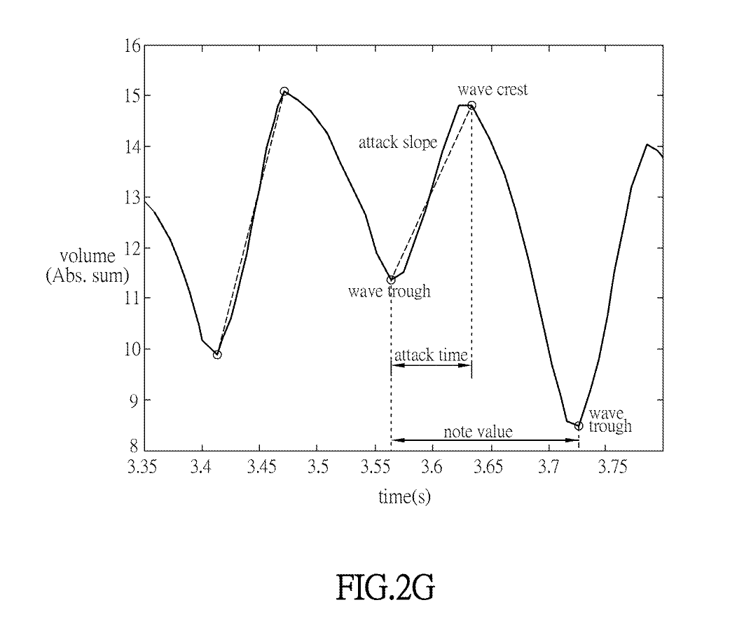

Refer to FIGS. 1A and 2B, wherein FIG. 1A is a schematic diagram of a two-dimensional emotion plane about the physiological emotion and the musical emotion and FIG. 1B is a function block diagram of an emotion regulation system 1 of an embodiment of the invention.

The emotion regulation system 1 can regulate a user's physiological emotion to a target emotion by a musical regulation method, and the target emotion can be set on a two-dimensional emotion plane in advance. As shown in FIG. 1A, the two-dimensional emotion plane is the plane composed of Valence and Arousal. This embodiment supposes that the user's present physiological emotion is at the position where the Valence and Arousal are both negative (can be called the negative emotion state) and the predetermined target emotion is at the position where the Valence and Arousal are both positive (can be called the positive emotion state). In other words, the emotion regulation system 1 can gradually regulate the user's emotion, for example, from the negative emotion state to the positive emotion state by music. Or, the user's emotion can be regulated from the positive emotion state to the peaceful state or to the negative emotion state. However, this invention is not limited thereto.

As shown in FIG. 1B, the emotion regulation system 1 includes a physiological emotion processing device 2 and a musical emotion processing device 3. In structure, the physiological emotion processing device 2 and the musical emotion processing device 3 can be separate components or integrated to one-piece unit. In this embodiment, the physiological emotion processing device 2 and the musical emotion processing device 3 are integrated to a one-piece earphone unit. Therefore, when the user wears the emotion regulation system 1 of the earphone component, the user's physiological emotion can be regulated.

The physiological emotion processing device 2 includes an emotion feature processing unit 21 and a physiological emotion analyzing unit 22. The physiological emotion processing device 2 further includes a physiological sensing unit 23.

The emotion feature processing unit 21 can output a physiological feature signal PCS according to a physiological signal PS generated by the user listening to a first music signal MS1. The physiological sensing unit 23 of this embodiment is an ear canal type measuring unit, which is used to sense the user's physiological emotion to obtain the physiological signal PS. The physiological sensing unit 23 includes three light sensing components, the light emitted by which can be red light, infrared light or green light, but this invention is not limited thereto. Each of the light sensing components can include a light emitting element and an optical sensing element, and the three light emitting elements can emit three lights which are separated by 120° from one another, so that the physiological signal PS can contain three physiological signal values which are separated by 120° from one another. The light emitting element can emit the light into the external auditory meatus. When the light comes out by being reflected by the external auditory meatus or diffracted by the internal portion of the body, the light can be received by the optical sensing element and then the optical sensing element outputs the physiological signal PS, which is a photoplethysmography (PPG). When the human pulse is generated, the blood flow in the blood vessel will be varied, which represents the contents of the hemoglobin and the deoxyhemoglobin in the blood vessel will also be varied. The hemoglobin and the deoxyhemoglobin are both very sensitive to the light of a particular wavelength (such as red light, infrared light or green light). Therefore, if the light emitting element (such as a light emitting diode) emits red light, infrared light or green light (the wavelength of red light ranges 622-770 nm, the wavelength of infrared light ranges 771-2500 nm, the wavelength of green light ranges 492-577 nm) to the tissue and the blood vessel under the skin of the external auditory meatus and then the optical sensing element (such as a photosensitive element) receives the light which is reflected or passes through the skin, the variation situation of the blood flow in the blood vessel can be obtained according to the intensity of the received light. This kind of the variation is called the PPG, which is a physical quantity generated due to the blood circulation system, wherein when the systole and diastole are generated, the blood flow in the blood vessel in a unit area will be cyclically varied. Because the PPG variation is caused due to the systole and diastole, the energy level of the reflected or diffracted light which is received by the optical sensing element can correspond to the pulsation. Therefore, by the physiological sensing unit 23 of the ear canal type, the human pulsation and the variation of the blood oxygen concentration can be detected and the user's physiological signal PS (which represents the user's present physiological emotion) can be thus obtained. The physiological signal PS can contain signals at multiple sampling times during a sensing period of time.

In practice, when the user determines the target emotion (supposed to be a positive emotion state) and wears the emotion regulation system 1 that is integrated to one-piece unit, the physiological sensing unit 23 can immediately sense the user's present physiological emotion (supposed to be a negative emotion state), the emotion regulation system 1 selects a first music signal MS1 (the music having positive Valence and positive Arousal, for example) according to the user's present physiological emotion and the selected target emotion and outputs the first music signal MS1 to the physiological emotion processing device 2 through a music output unit (not shown), and the physiological emotion processing device 2 plays the music for the user through a music output unit. After the user listens to the first music signal MS1, the physiological sensing unit 23 will sense the physiological signal PS again of the user listening to the first music signal MS1, the emotion feature processing unit 21 analyzes the present physiological signal PS to output the corresponding physiological feature signal PCS, and the physiological emotion analyzing unit 22 can analyze the physiological emotion generated by the user when listening to the first music signal MS1 and generate a physiological emotion state signal PCSS. Therefore, the physiological emotion state signal PCSS includes the physiological emotion reaction of the user listening to the first music signal MS1 (the physiological emotion reaction can correspond to a position on the two-dimensional emotion plane).

The musical emotion processing device 3 is electrically connected with the physiological emotion processing device 2 and includes a music feature processing unit 31 and a music emotion analyzing processing unit 32. The musical emotion processing device 3 can further include a music signal input unit 33. The music signal input unit 33 inputs a plurality of music signals MS to the music feature processing unit 31. The multiple music signals MS are multiple music songs.

The music feature processing unit 31 can obtain a plurality of corresponding music feature signals MCS from the inputted music signals MS. Each of the music feature signals MCS can have a plurality of music feature values of the music signal MS, and the music emotion analyzing processing unit 32 can analyze the musical emotion of each of the music signals MS from the music feature signals MCS. In other words, the music emotion analyzing processing unit 32 can analyze the music feature signals MCS to obtain the musical emotion corresponding to each of the music signals MS, so that the position of the musical emotion corresponding to each of the music signals MS can be found on the two-dimensional emotion plane, like the physiological emotion. To be noted, the music feature processing unit 31 and the music emotion analyzing processing unit 32 can process and analyze the music signals MS and obtain the musical emotion corresponding to each of the music signals MS before regulating the user's emotion.

Moreover, after the physiological emotion processing device 2 generates the physiological emotion state signal PCSS, the music emotion analyzing processing unit 32 can output a corresponding second music signal MS2 to the user according to the physiological emotion state signal PCSS and the target emotion. In other words, the music emotion analyzing processing unit 32 can compare the physiological emotion state signal PCSS generated by the user listening to the first music signal MS1 with the target emotion, and if they don't conform to each other, the music emotion analyzing processing unit 32 can select, from the musical emotions of the music signals MS, the second music signal MS2 that can regulate the user′ emotion to the target emotion. To be noted, the signal (such as the physiological emotion state signal PCSS, the first music signal MS1 and the second music signal MS2) transmission between the physiological emotion processing device 2 and the musical emotion processing device 3 can be implemented by a wireless transmission module or a wired transmission module. The transmission manner of the wireless transmission module can be one of a radio frequency transmission manner, an infrared transmission manner and a Bluetooth transmission manner, but however, this invention is not limited thereto.

If the physiological emotion generated by the user listening to the second music signal MS2 doesn't conform with the target emotion, the music emotion analyzing processing unit 32 can select a third music signal and transmit it to the user so as to gradually regulate the user's emotion to the target emotion.

Refer to FIG. 1C for a further illustration of the detailed operation of the emotion regulation system 1. FIG. 1C is another function block diagram of the emotion regulation system 1.

In this embodiment, the emotion feature processing unit 21 includes a physiological feature generation element 211 and a physiological feature dimension reduction element 212. The physiological feature extraction element 211 uses a physiological feature extraction method to analyze the physiological signal PS generated by the user listening to the music signal so as to obtain a plurality of physiological features. The physiological feature extraction method can be a time domain feature extraction method, a frequency domain feature extraction method, a nonlinear feature extraction method or their any combination. However, this invention is not limited thereto.

The time domain feature extraction method is the analysis implemented for the time domain variation of the pulsation signal, and the typical analysis method is the statistical method, which executes the various computations about the variation magnitude in statistics within a pulsation duration to obtain the time domain index of the pulsation rate variation (PRV). The time domain feature extraction method can include at least one of the SDNN (standard deviation of normal to normal (NN) intervals, representing the variability of the total pulsation), the RMSSD (root mean square of successive differences, which can estimate the variability of a short-term pulsation), the NN 50 count (the number of pairs of successive NN intervals that differ by more than 50 ms), the pNN50 (the proportion of NN50 divided by total number of NN intervals), the SDSD (the standard deviation of the successive differences between adjacent NN intervals), the BPM (beat per minute), the median PPI (the median of the P wave interval, the median of the NN intervals), the IQRPPI (the interquartile rang of the P wave interval, the first quartile of the NN intervals), the MAD PPI (the mean absolute deviation of the P wave interval, the mean deviation of the NN intervals), the Diff PPI (the mean of the difference of the P wave intervals, the absolute difference of the NN intervals), the CV PPI (the coefficient of variation of the P wave interval, the coefficient of variation of the NN intervals) and the Range (the range of the P wave interval, the difference between the largest NN interval and the smallest NN interval).

The frequency domain feature extraction method is to use the Discrete Fourier Transform (DFT) to transform the time series of the pulsation interval to the frequency domain and use the power spectral density (PSD) or the spectrum distribution to acquire the frequency domain index of the PRV (such as HF, LF). The frequency domain feature extraction method can include at least one of the VLF power (very low frequency power with a frequency range of 0.003-0.04 Hz), the LF power (low frequency power with a frequency range of 0.04-0.15 Hz), the HF power (high frequency power with a frequency range of 0.15-0.4 Hz), the TP of the pulsation variation spectrum analysis (total power with a frequency range of 0.003-0.4 Hz), the LF/HF (the ratio of the LF power to the HF power), the LFnorm (the normalized LF power), the HFnorm (the normalized HF power), the pVLF (the proportion of the VLF power, the proportion of the VLF power to the total power), the pLF (the proportion of the LF power, the proportion of the LF power to the total power), the pHF (the proportion of the HF power, the proportion of the HF power to the total power), the VLFfr (the peak value of the VLF power, the frequency of the peak in the VLF range), the LFfr (the peak value of the LF power, the frequency of the peak in the LF range) and the HFfr (the peak value of the HF power, the frequency of the peak in the HF range).

The nonlinear feature extraction method can include at least one of the Poincaré Poincar Plot with the clockwise rotation of y axis for 45°, the standard deviation of the P wave distribution (SDI, the ellipse width, representing the short-term pulsation variability), the Poincaré Poincar Plot with the clockwise rotation of x axis for 45°, the standard deviation of the P wave distribution (SD2, the ellipse length, representing the long-term pulsation variability) and the ratio of the SD1 to the SD2 (SD12, the activity index of the sympathetic nerve). The Poincaré Poincar Plot of the nonlinear dynamic pulsation variability analysis method is to use the geometry manner, in the time domain, to scatter the original heartbeat intervals and plot them on the same 2D diagram so as to show the relationship of the successive intervals.

The physiological feature dimension reduction element 212 uses a physiological feature reduction method to select at least a physiological feature from the physiological features generated by the physiological feature acquiring element 211 to output the physiological feature signal PCS. The physiological feature reduction method can be a linear discriminant analysis method, a principal component analysis method, an independent component analysis method, a generalized discriminant analysis method or their any combination. However, this invention is not limited thereto. The linear discriminant analysis method can separate the physiological features outputted by the physiological feature acquiring element 211 into different signal groups and minimize the distribution spaces of the groups to obtain the physiological feature signal PCS. The principal component analysis method is to regard a part of the physiological feature obtained by the physiological feature acquiring element 211 as the all features of the physiological features to obtain the physiological feature signal PCS. The independent component analysis method is to convert the physiological features which have the relationship therebetween into the independent features to obtain the physiological feature signal PCS. The generalized discriminant analysis is to convert the physiological features into the kernel function space, separate them into different signal groups and minimize the distribution spaces of the signal groups to obtain the physiological feature signal PCS.

As shown in FIG. 1C, the physiological emotion analyzing unit 22 of this embodiment includes a physiological emotion identifying element 221, a physiological emotion storing element 222 and a physiological emotion displaying element 223. The physiological emotion identifying element 221 can identify the physiological feature signal PCS outputted by the physiological feature dimension reduction element 212 and generate the physiological emotion state signal PCSS. In other words, the physiological emotion identifying element 221 can identify which kind of the physiological emotion the physiological feature signal PCS belongs to, and the physiological emotion state signal PCSS contains the physiological emotion reaction signal of the user listening to the first music signal MS1. The physiological emotion storing element 222 can store the relationship between the physiological feature signal PCS and the physiological signal PS. The physiological emotion displaying element 223 can display the physiological emotion state obtained after the physiological emotion identifying element 221 identifies the PCS, i.e. the physiological emotion state of the user after listening to the first music signal MS1.

The music feature processing unit 31 includes a music feature acquiring element 311 and a music feature dimension reduction element 312. The music feature acquiring element 311 uses a music feature extraction method to analyze the multiple music signals MS to obtain the multiple corresponding music features (one music signal MS can contain a plurality of music features). The music feature extraction method can be a timbre feature extraction method, a pitch feature extraction method, a rhythm feature extraction method, a dynamic feature extraction method or their any combination. However, this invention is not limited thereto.

The timbre feature extraction method can include at least one of the brightness features, the spectral rolloff feature and Mel-scale Frequency Cepstral Coefficients (MFCCs) features. As shown in FIG. 2A, the brightness uses the ratio of the energy of the frequency over 1500 Hz to the total energy and the ratio of the energy of the frequency over 3000 Hz to the total energy as the brightness features. Moreover, as shown in FIG. 2B, the spectral rolloff uses the frequency (such as 6672.6 Hz) which is computed such that the energy thereunder takes 85% of the total energy and the frequency (such as 8717.2 Hz) which is computed such that the energy thereunder takes 95% of the total energy as the spectral rolloff features. The MFCCs provide a spectrogram describing the sound shape, wherein the MFCCs consider the human auditory system are more sensitive to the low frequency, so the low frequency portion will be taken more and the high frequency portion will be taken less when acquiring the parameters. Therefore, for the recognition rate, the MFCCs have a better recognition effect than the linear Cepstral Coefficients. At first, the frames of the music signal are made a series of the frame spectrum sequence by the Fast Fourier Transform (FFT). The Fourier Transform re-expresses the original signal by the sine function and the cosine function, and the components of the original signal can be obtained by the Fourier Transform. Then, the absolute amplitude spectrum of each of the frames is sent to a triangular filter banks, wherein the center of the frequency band is the Mel scale value and the bandwidth thereof is the difference between the two successive Mel scale values. Subsequently, the energy value of each frequency band is computed, and then the logarithmic energy values of the all frequency bands are processed by the discrete cosine transform (DCT) to obtain the Cepstral coefficients, i.e. the MFCCs. Since the MFCCs consider the human auditory system are more sensitive to the low frequency, the first thirteen portions (which mostly are low frequency portions) are adopted when the parameters are acquired.

The pitch feature extraction method can include at least one of the mode features, the harmony features and the pitch features. The mode is the collection of the sounds having different pitches, and these sounds have a specific pitch interval relationship therebetween and play different roles in the mode. The mode is one of the important factors that decides the music style and the positive or negative feeling of the emotion. As shown in FIG. 2C, where the audio frequency diagram is transformed into the pitch distribution diagram by the logarithmic transformation, the sounds with the same intonation and different pitch (of an octave relationship) are overlapped to obtain the music chromagram, as shown in FIG. 2D, and then the obtained chromagram and various music chromagrams of major scale and minor scale are put into the correlation analysis. Then, the correlated coefficients of the most highly correlated major scale and minor scale are treated with a subtraction to obtain the main mode of the music signal of the segment, and besides, the music signal of this segment can be determined as belonging to the major scale or the minor scale according to the difference between the sum of the correlated coefficients of the major scales and the sum of the correlated coefficients of the minor scales. The harmony refers to the harmonic or disharmonic effect obtained when different pitches are played at the same time. After transforming the music signal into the frequency domain signal, the features such as the disharmonic overtone and the roughness can be acquired according to the relationship between the fundamental frequency and other frequencies. Besides, the pitch is another important feature of the audio signal, representing the magnitude of the audio frequency, and the audio frequency refers to the fundamental frequency. The transformation from the fundamental frequency to the semitone can tell that each gamut includes twelve semitones, the frequency will be doubled when the next gamut arrives and the linear feeling of the human ear to the pitch is directly proportional to the logarithm value of the fundamental frequency. As to the pitch feature, the mean value, standard deviation, median or range thereof can be used as the representative feature thereof.

The rhythm feature extraction method can include at least one of the tempo features, the rhythm variation features and the articulation features. The tempo is generally marked at the beginning of a music song by characters or numerals, and the unit is the beats per minute (BPM) in the modern usage. After reading in the music signal, the feature of the music signal in the volume variation can be found by the computation, as shown in FIG. 2E, and the outline is called the envelope, the peak value is found to obtain the BPM, as shown in FIG. 2F. Moreover, the rhythm variation is the variation of computing the note value. The note value can be computed according to the distance from wave trough to wave trough. The variation of the note value can be obtained by the computation. The articulation is the direction or technology of the music, which affects the transition or continuity between the musical notes of the music song. For the music, there are many different kinds of the articulation, which have different effects, such as slur, ligature, staccato, staccatissimo, accent, sforzando and rinforzando, or legato. Therefore, the computation thereof refers to the mean of the ratio of the attack time of each of the musical notes to the note value, and the attack time is the time from wave trough to wave crest, as shown in FIG. 2G.

The dynamic feature extraction method can include at least one of the average loudness features, the loudness variation features and the loudness range features. The dynamic represents the intensity of the sound, which is also called the volume, intensity or energy. A music song can be cut into multiple frames, and the magnitude of the signal amplitude in each of the frames can be analogized with the volume variation of the music song. Basically, the volume value can be computed by two methods, wherein one method is to compute the sum of the absolute value of each of the frames, and the other one is to compute the sum of the squared value of each of the frames and take the logarithm value with base 10 of the sum into the multiplication by 10. As to the average loudness, the average of the volume values of the all frames is regarded as the average loudness feature. Moreover, as to the loudness variation, the standard deviation of the volume values of the all frames is regarded as the loudness variation feature. As to the loudness range, the difference between the maximum volume of the volume values of the all frames and the minimum volume of the volume values of the all frames is regarded as the loudness range feature.

As shown in FIG. 1C, the music feature dimension reduction element 312 selects at least one music feature from the music signals MS by a music feature reduction method to obtain the corresponding music feature signals MCS. The music feature reduction method also can be at least one of a linear discriminant analysis method, a principal component analysis method, an independent component analysis method and a generalized discriminant analysis method. The linear discriminant analysis method, the principal component analysis method, the independent component analysis method and the generalized discriminant analysis method have been illustrated in the above description so the related illustrations are omitted here for conciseness.

The music emotion analyzing processing unit 32 includes a music emotion analyzing determining element 321, a personal physiological emotion storing element 322 and a music emotion components displaying element (not shown). The personal physiological emotion storing element 322 receives the physiological emotion state signal PCSS outputted by the physiological emotion identifying element 221 and stores the relationship between the physiological emotion state signal PCSS and the first music signal MS1 (i.e. the relationship between the personal emotion of the user after listening to the first music signal MS1 and the music feature signal MCS of the first music signal MS1).

The music emotion analyzing determining element 321 analyzes the music feature signals MCS of the music signals MS to obtain the musical emotion of each of the music signals MS, and compares the physiological emotion state signal PCSS with a target emotion signal of the target emotion to output the second music signal MS2. Physically, the music emotion analyzing determining element 321 can analyze the music feature signals MCS to obtain the musical emotion of each of the music signals MS. The musical emotion of each of the music signals MS can correspond to the two-dimensional emotion plane of FIG. 1A and have a corresponding position on the plane composed of the Valence and the Arousal. The music emotion analyzing determining element 321 can analyze the musical emotion of the first music signal MS1 and the physiological emotion state signal PCSS and generate a music emotion mark signal, and the music emotion components displaying element can display the result of the music emotion mark signal. In addition, if the physiological emotion state signal PCSS generated by the user after listening to the first music signal MS1 doesn't conform with the predetermined target emotion signal, that is, some parameter values of the both are without the specific tolerance range, it represents the user's physiological emotion has not been regulated to the target emotion. Therefore, the music emotion analyzing determining element 321 can find another music (the second music signal MS2) from the musical emotions of the music signals MS and then send the second music signal MS2 to the user, and the user can listen to the second music signal MS2 so that the physiological emotion thereof can be regulated again. When the user listens to the second music signal MS2, the corresponding physiological feature signal PCS can be obtained again. Then, the physiological emotion identifying element 221 can identify the physiological feature signal PCS corresponding to the second music signal MS2 again and generate the corresponding physiological emotion state signal PCSS, and the music emotion analyzing determining element 321 repeats the comparison between the physiological emotion state signal PCSS and the predetermined target emotion signal, and the rest can be deduced by analogy. If some parameters of the physiological emotion state signal PCSS and target emotion signal are within the specific tolerance range, it represents the both conform to each other, that is, the user's physiological emotion has been regulated to the target emotion, so the regulation of the user's physiological emotion state is finished.

To be noted, the above-mentioned emotion feature processing unit 21, physiological emotion analyzing unit 22, music feature processing unit 31 or music emotion analyzing processing unit 32 can be realized by software programs and can be executed by a processor (such as a microcontroller unit, MCU). Otherwise, the functions of the emotion feature processing unit 21, physiological emotion analyzing unit 22, music feature processing unit 31 or music emotion analyzing processing unit 32 can be realized by hardware or firmware. However, this invention is not limited thereto.

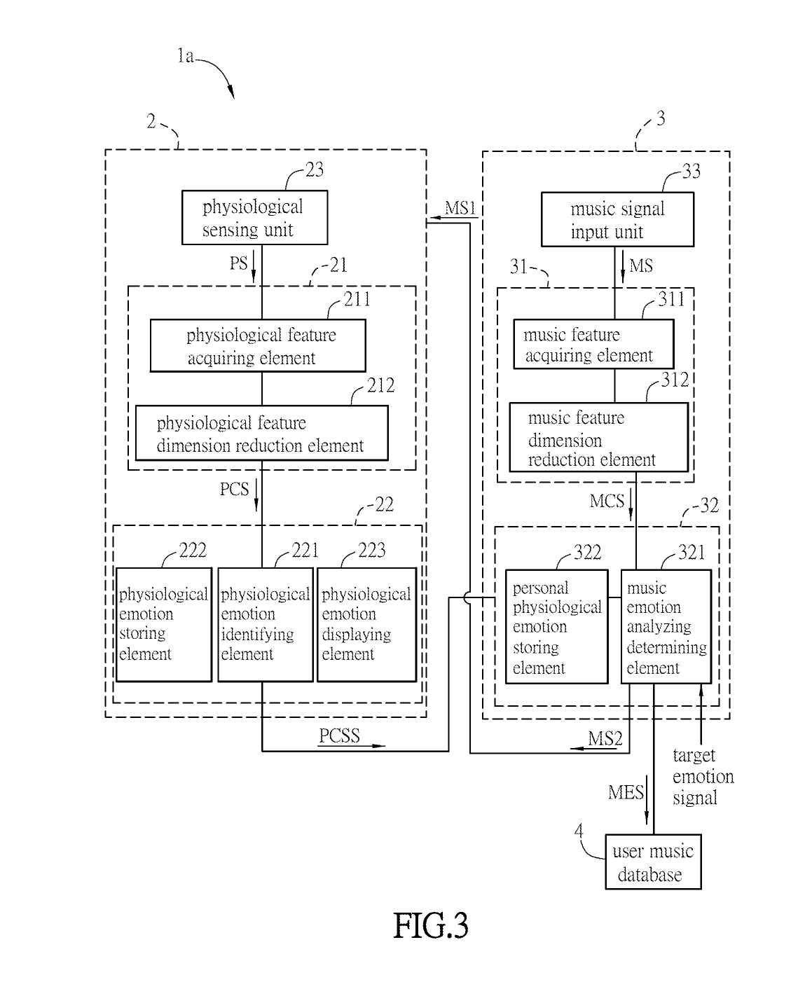

Refer to FIG. 3, which is a function block diagram of an emotion regulation system 1a of another embodiment of the invention.

The main difference from the emotion regulation system 1 in FIG. 1C is that the emotion regulation system 1a further includes a user music database 4, which is electrically connected to the music emotion analyzing determining element 321. The music emotion analyzing determining element 321 can further compare the physiological emotion state signal PCSS with the music feature signal MCS corresponding to the first music signal MS1 (or the second music signal MS2) and output a music emotion mark signal MES, and the user music database 4 can receive the music emotion mark signal MES. Thereby, the personalized music emotion database of the user can be structured. Afterwards, if the emotion of the same user needs to be regulated, the music, which the user has ever listened to such that the user's emotion which is similar to or the same as the currently detected emotion can be regulated to the target emotion, can be found by the comparison and search in the personalized musical emotion database, and then the above-mentioned music file can be selected from the music signals MS and can act as the music that is predetermined to be played for the user's listening.

Other technical features of the emotion regulation system 1a can be comprehended by referring to the emotion regulation system 1, and the related illustrations are omitted here for conciseness.

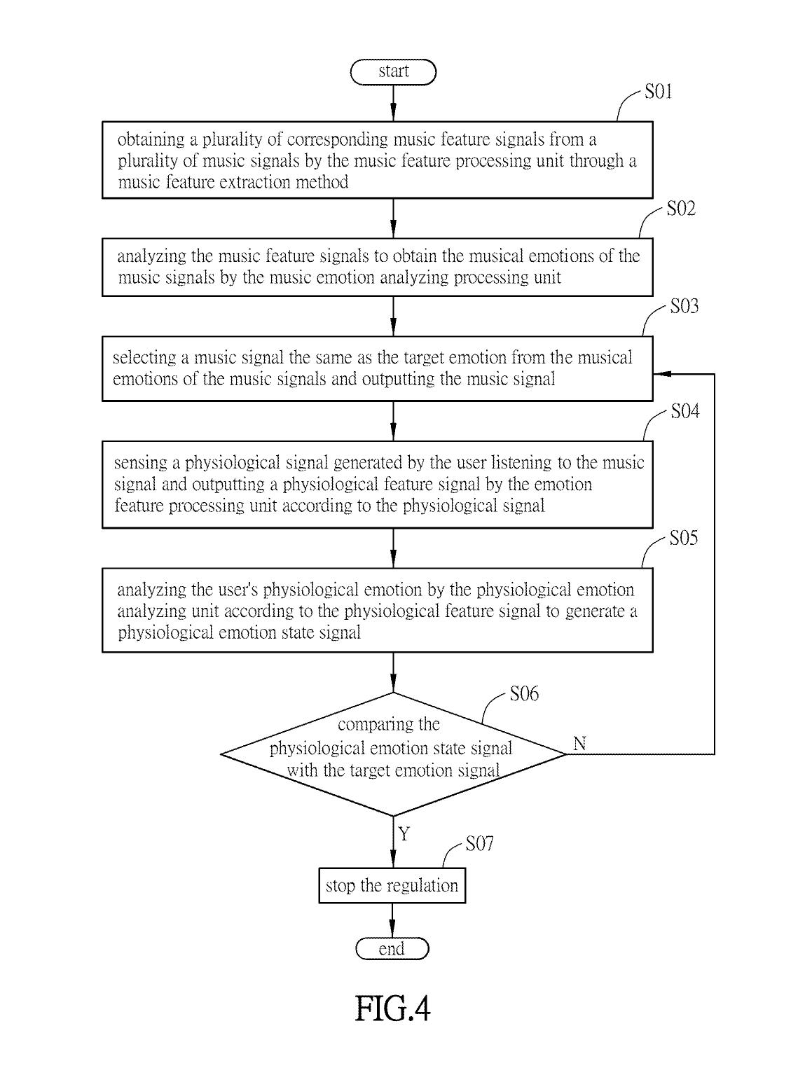

Refer to FIG. 4, which is a schematic flowchart of an emotion state regulation method of an embodiment of the invention.

The emotion state regulation method is applied with the above-mentioned emotion regulation system 1 (or 1a) and can regulate the user's physiological emotion to the target emotion. Since the emotion regulation system 1 (or 1a) has been illustrated in the above description, the related illustrations are omitted here for conciseness.

By taking the cooperation of the emotion state regulation method and the emotion regulation system 1 as an example, as shown in FIGS. 1C and 4, the emotion state regulation method can include the following steps. Firstly, the step S01 is obtaining a plurality of corresponding music feature signals MCS from a plurality of music signals MS by the music feature processing unit 31 through a music feature extraction method. In this embodiment, the music feature acquiring element 311 of the music feature processing unit 31 analyzes the music signals MS by the music feature extraction method to obtain the corresponding multiple music features. Moreover, the music feature dimension reduction element 312 of the music feature processing unit 31 selects at least one music feature from the music features of the music signals MS by a music feature reduction method to obtain the music feature signal MCS corresponding to the music signal MS.

Then, the step S02 is implemented. The step S02 is analyzing the music feature signals MCS to obtain the musical emotions of the music signals MS by the music emotion analyzing processing unit 32. Herein, the music emotion analyzing determining element 321 analyzes the music feature signals MCS corresponding to the music signals MS to obtain the musical emotion of each of the music signals MS. The musical emotion of each of the music signals MS can have a corresponding position on the two-dimensional emotion plane.

Then, the step S03 is implemented. The step S03 is selecting a music signal the same as the target emotion from the musical emotions of the music signals MS and playing it for the user's listening. Physically, when a target emotion signal of the target emotion is received, the music emotion analyzing determining element 321 can select the music having the emotion the same as the target emotion that the user wants, generate the music signal (such as the first music signal MS1), output the first music signal MS1 to the physiological emotion processing device 2 through the music output unit (not shown) and play it for the user's listening.

Then, the step S04 is implemented. The step S04 is sensing a physiological signal PS generated by the user listening to the music signal and outputting a physiological feature signal PCS by the emotion feature processing unit 21 according to the physiological signal PS. Herein, the physiological sensing unit 23 can sense the physiological signal PS of the user listening to the first music signal MS1, and the physiological feature acquiring element 211 and the physiological feature dimension reduction element 212 of the emotion feature processing unit 21 can analyze the present physiological signal PS to output the corresponding physiological feature signal PCS.

Then, the step S05 is implemented. The step S05 is analyzing the user's physiological emotion by the physiological emotion analyzing unit 22 according to the physiological feature signal PCS to generate a physiological emotion state signal PCSS. Herein, the physiological emotion identifying element 221 of the physiological emotion analyzing unit 22 analyzes the physiological emotion generated by the user listening to the first music signal MS1 according to the physiological feature signal PCS and generates the corresponding physiological emotion state signal PCSS. The physiological emotion state signal PCSS includes the physiological emotion reaction of the user listening to the first music signal MS1.

Then, the step S06 is implemented. The step S06 is comparing the physiological emotion state signal PCSS with the target emotion signal of the target emotion by the music emotion analyzing processing unit 32. When the physiological emotion state signal PCSS and the target emotion signal don't conform to each other (representing some parameters of the both are without the specific tolerance range), it represents the user's physiological emotion has not been regulated to the target emotion. So, the method goes back to the step S03, which is selecting another music signal (such as the second music signal MS2) the same as the target emotion from the musical emotions of the music signals MS and outputting the second music signal MS2. Then, the steps S04 to S06 including sensing the physiological state, analyzing the physiological emotion and the comparing step are repeated. The regulation is stopped (step S07) when the user's physiological emotion state conforms to the target emotion.

Other technical features of the emotion state regulation method have been illustrated in the description of the emotion regulation system 1 (or 1a), so the related illustrations are omitted here for conciseness.

In another embodiment, as shown in FIG. 3, the regulation method can further include a step as follows. The music emotion analyzing determining element 321 of the music emotion analyzing processing unit 32 compares the physiological emotion state signal PCSS with the music feature signal MCS corresponding to the first music signal MS1 (or the second music signal MS2) and outputs a music emotion mark signal MES, and the user music database 4 receives the music emotion mark signal MES. Thereby, the personalized music emotion database of the user can be structured.

Summarily, in the emotion regulation system and the regulation method thereof according to this invention, the emotion feature processing unit of the physiological emotion processing device can output the physiological feature signal according to the physiological signal generated by the user listening to the first music signal, and the physiological emotion analyzing unit analyzes the user's physiological emotion according to the physiological feature signal and generates the physiological emotion state signal. Moreover, the music feature processing unit of the musical emotion processing device can obtain a plurality of corresponding music feature signals from a plurality of music signals, and the music emotion analyzing processing unit analyzes the music feature signals to obtain the musical emotions of the music signals and outputs the corresponding second music signal to the user according to the physiological emotion state signal and the target emotion. Thereby, the emotion regulation system and the regulation method of this invention can gradually regulate the user's physiological emotion to the predetermined target emotion, so as to enhance the human physiological and psychological health.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An emotion regulation system regulating a physiological emotion of a user to a target emotion, and comprising:
a physiological emotion processing device comprising an emotion feature processing unit and a physiological emotion analyzing unit, wherein the emotion feature processing unit outputs a physiological feature signal according to a physiological signal generated by the user listening to a first music signal, and the physiological emotion analyzing unit analyzes the user's physiological emotion according to the physiological feature signal and generates a physiological emotion state signal; and
a musical emotion processing device electrically connected with the physiological emotion processing device and comprising a music feature processing unit and a music emotion analyzing processing unit, wherein the music feature processing unit obtains a plurality of corresponding music feature signals from a plurality of music signals, and the music emotion analyzing processing unit analyzes the music feature signals to obtain musical emotions of the music signals and outputs a corresponding second music signal to the user according to the physiological emotion state signal and the target emotion.

2. The emotion regulation system as recited in claim 1, wherein the physiological emotion processing device and the musical emotion processing device are integrated to one-piece unit.

3. The emotion regulation system as recited in claim 1, wherein the physiological emotion processing device further includes a physiological sensing unit, which senses the user listening to the first music signal to output the physiological signal.

4. The emotion regulation system as recited in claim 3, wherein the physiological sensing unit comprises three light sensing components, the light emitted by which are red light, infrared light or green light.

5. The emotion regulation system as recited in claim 1, wherein the emotion feature processing unit comprises a physiological feature acquiring element and a physiological feature dimension reduction element, the physiological feature acquiring element uses a physiological feature extraction method to analyze the physiological signal to obtain a plurality of physiological features, and the physiological feature dimension reduction element uses a physiological feature reduction method to select at least a physiological feature from the physiological features to output the physiological feature signal.

6. The emotion regulation system as recited in claim 5, wherein the physiological feature extraction method is a time domain feature extraction method, a frequency domain feature extraction method, a nonlinear feature extraction method or their any combination.

7. The emotion regulation system as recited in claim 5, wherein the physiological feature reduction method is a linear discriminant analysis method, a principal component analysis method, an independent component analysis method, a generalized discriminant analysis method or their any combination.

8. The emotion regulation system as recited in claim 1, wherein the physiological emotion analyzing unit comprises a physiological emotion identifying element, which identifies the physiological feature signal and generates the physiological emotion state signal.

9. The emotion regulation system as recited in claim 1, wherein the music feature processing unit comprises a music feature acquiring element and a music feature dimension reduction element, the music feature acquiring element uses a music feature extraction method to analyze the music signals to obtain a plurality of corresponding music features, and the music feature dimension reduction element selects at least one music feature from the music features of the music signals by a music feature reduction method to obtain a plurality of corresponding music feature signals.

10. The emotion regulation system as recited in claim 9, wherein the music feature extraction method is a timbre feature extraction method, a pitch feature extraction method, a rhythm feature extraction method, a dynamic feature extraction method or their any combination.

11. The emotion regulation system as recited in claim 10, wherein the timbre feature extraction method comprises at least one of brightness features, spectral rolloff features and Mel-scale Frequency Cepstral Coefficients (MFCCs) features.

12. The emotion regulation system as recited in claim 10, wherein the pitch feature extraction method comprises at least one of mode features, harmony features and pitch features.

13. The emotion regulation system as recited in claim 10, wherein the rhythm feature extraction method comprises at least one of tempo features, rhythm variation features and articulation features.

14. The emotion regulation system as recited in claim 10, wherein the dynamic feature extraction method comprises at least one of average loudness features, loudness variation features and loudness range features.

15. The emotion regulation system as recited in claim 1, wherein the music emotion analyzing processing unit comprises a personal physiological emotion storing element and a music emotion analyzing determining element, the personal physiological emotion storing element receives the physiological emotion state signal and stores the relationship between the physiological emotion state signal and the first music signal, and the music emotion analyzing determining element analyzes the music feature signals to obtain musical emotions of the music signals and compares the physiological emotion state signal with a target emotion signal of the target emotion to output the second music signal.

16. The emotion regulation system as recited in claim 15, further comprising:
a user music database electrically connected to the music emotion analyzing determining element, wherein the music emotion analyzing determining element further compares the physiological emotion state signal with the music feature signal corresponding to the first music signal and outputs a music emotion mark signal, and the user music database receives the music emotion mark signal to structure a personalized music emotion database of the user.

17. An emotion state regulation method applied with an emotion regulation system for regulating a physiological emotion of a user to a target emotion, wherein the emotion regulation system comprises a physiological emotion processing device and a musical emotion processing device, the physiological emotion processing device comprises an emotion feature processing unit and a physiological emotion analyzing unit and the musical emotion processing device comprises a music feature processing unit and a music emotion analyzing processing unit, the regulation method comprising steps of:
obtaining a plurality of corresponding music feature signals from a plurality of music signals by the music feature processing unit through a music feature extraction method;
analyzing the music feature signals to obtain musical emotions of the music signals by the music emotion analyzing processing unit;
selecting a first music signal the same as the target emotion from the musical emotions of the music signals and outputting the first music signal;
sensing a physiological signal generated by the user listening to the music signal and outputting a physiological feature signal by the emotion feature processing unit according to the physiological signal;
analyzing the user's physiological emotion by the physiological emotion analyzing unit according to the physiological feature signal to generate a physiological emotion state signal;
comparing the physiological emotion state signal with a target emotion signal of the target emotion by the music emotion analyzing processing unit; and
selecting a second music signal the same as the target emotion from the musical emotions of the music signals and outputting the second music signal, when the physiological emotion state signal and the target emotion signal don't conform to each other.

18. The regulation method as recited in claim 17, wherein the music feature processing unit comprises a music feature acquiring element and the regulation method further comprises a step of:
analyzing the music signals by the music feature extraction method to obtain a plurality of corresponding music features by the music feature acquiring element.

19. The regulation method as recited in claim 17, wherein the music feature extraction method is a timbre feature extraction method, a pitch feature extraction method, a rhythm feature extraction method, a dynamic feature extraction method or their any combination.

20. The regulation method as recited in claim 19, wherein the music emotion analyzing processing unit comprises a music emotion analyzing determining element and the regulation method further comprises a step of:
comparing the physiological emotion state signal with the music feature signal corresponding to the first music signal to output a music emotion mark signal to structure a personalized music emotion database of the user.
